(19) United States
(12) Patent Application Publication
(10) Pub. No.: US 2025/0362256 A1
(43) Pub. Date: Nov. 27, 2025

(54) X-RAY OPTICAL DEVICE AND X-RAY PHOTOELECTRON SPECTROSCOPY

(71) Applicant: RIGAKU CORPORATION, Tokyo (JP)

(72) Inventors: Licai JIANG, Auburn Hills, MI (US); Kiyoshi OGATA, Tokyo (JP); Kazuhiko OMOTE, Tokyo (JP); Markus KUHN, The Woodlands, TX (US); Naoki MATSUSHIMA, Tokyo (JP)

(73) Assignee: RIGAKU CORPORATION, Tokyo (JP)

(21) Appl. No.: 19/204,578

(22) Filed: May 11, 2025

Related U.S. Application Data
(60) Provisional application No. 63/650,158, filed on May 21, 2024.
(60) Provisional application No. 63/650,573, filed on May 22, 2024.

(51) Int. Cl. G01N 23/2273; H01J 35/10; H01J 35/14

(52) U.S. Cl. CPC G01N 23/2273; H01J 35/10; H01J 35/147; G01N 2223/085; G01N 2223/309; G01N 2223/315; G01N 2223/316

(57) ABSTRACT

An X-ray photoelectron spectroscopy of the present invention equipped with a sample stage (1) having a movable range where it is possible to inspect the entire surface of a semiconductor wafer having a diameter of 300 mm or more, including an X-ray optical device (2) that is configured to include a rotating anode type X-ray source (20) and an X-ray optical system (30) as components, the X-ray optical system (30) being configured such that X-rays of a specific bandwidth from X-rays collimated by a collimating optical system (31) are extracted by a planar crystal optical system (32), and the X-rays of the specific bandwidth are focused by a focusing optical system (33) to irradiate the surface of the semiconductor wafer with the X-rays.

### BACKGROUND OF THE INVENTION

### Field of the Invention

The present invention relates to an X-ray photoelectron spectroscopy equipped with a sample stage having a movable range that enables inspection of the entire surface of a semiconductor wafer having a diameter of 300 mm or more, and an X-ray optical device suitable for the same.

### Description of the Related Art

An X-ray photoelectron spectroscopy (XPS) is an apparatus for non-destructively analyzing the composition and bonding state of elements in the neighborhood of a solid surface. It is also suitable for analyzing a thin film formed on the surface of a semiconductor wafer, and various companies have developed such apparatuses for analyzing semiconductor wafers (see, for example, Prior Art Examples 1 to 3). The following patent literature also discloses invention related to hard X-ray photoelectron spectroscopy.

### Prior Art Example 1

https://www.novami.com/nova-technology/x-ray-photoelectron-spectroscopy-xps/

### Prior Art Example 2

http://www.ph.unito.it/dfs/solid/Strumentazione/XPS/micro-focus.PDF

### Prior Art Example 3

https://scientaomicron.com/en/products-solutions/electron-spectroscopy/HAXPES-Lab

### Patent Literature: Japanese Unexamined Patent Application Publication No. 2016-212076 (JP 2016-212076 A)

The semiconductor manufacturing technique has been developing day by day, and in recent years, the development of semiconductor ingots from which semiconductor wafers having a diameter of 300 mm or more has been progressing. Furthermore, microstructural evolution of circuit patterns to be formed on the surfaces of semiconductor wafers has also been progressing, and there is a demand for analysis of regions of 50 μm or less (preferably 20 μm or less) as inspection targets. Therefore, in order to achieve this demand, it is necessary to focus X-rays to a full width at half maximum (FWHM) of 50 μm or less (preferably 20 μm or less).

As shown in FIG. 10, X-ray photoelectron spectroscopies of the above-mentioned Prior Art Examples 1 and 2 are configured such that an electron beam emitted from an electron gun 101 is caused to impinge on an anode 102, and X-rays emitted from the surface of the anode 102 are reflected at a high angle by a bent-crystal monochromator 103 and focused on the surface of a semiconductor wafer S (sample).

High energy resolution can be obtained by reflecting X-rays at a high angle with the bent-crystal monochromator 103. However, there is a problem that a surface error occurs on a curved surface, resulting in an increase of the focal size of the X-rays on the sample surface and reduction in the intensity (brightness) of the X-rays.

Furthermore, in the configuration in which X-rays are reflected at a high angle with the bent-crystal monochromator 103, the arrangement position of an X-ray source 100 including the electron gun 101 and anode 102 is close to a sample stage 104 on which the semiconductor wafer S is placed, so that there is a risk that the movement range of the sample stage 104 may be limited by the X-ray source 100.

The X-ray photoelectron spectroscopy of Prior Art Example 3 is equipped with a liquid metal jet anode X-ray source that implements high brightness and microfocus. However, since this X-ray source emits X-rays in a horizontal direction, it is necessary a that the surface of semiconductor wafer as a measurement target surface is arranged in a vertical direction. This causes a problem that a transport mechanism for mounting the semiconductor wafer on the sample stage is complicated.

Furthermore, the invention relating to the hard X-ray photoelectron spectroscopy disclosed in the above Patent Literature is configured such that the X-ray source 3 approaches to a sample 5 as shown in FIG. 5(b) to FIG. 7, FIG. 9, and FIG. 12 of the Patent Literature. Therefore, there is a risk that the movement range of the sample stage 104 may be limited by the X-ray source 100 as shown in FIG. 10 of the present application.

### SUMMARY OF THE INVENTION

The present invention has been made in consideration of the above-mentioned circumstances, and has an object to provide an X-ray optical device that can focus X-rays with high brightness to a microfocus.

Furthermore, the present invention also has an object to provide an X-ray photoelectron spectroscopy that can analyze a thin film formed on the surface of a semiconductor wafer having a diameter of 300 mm or more with high precision over an entire surface of the thin film.

In order to attain the above objects, an X-ray optical device according to the present invention that is incorporated in an X-ray photoelectron spectroscopy including a sample stage having a movable range where it is possible to inspect an entire surface of a semiconductor wafer having a diameter of 300 mm or more, and irradiates the surface of the semiconductor wafer with X-rays, comprises:
a rotating anode type X-ray source that includes an electron gun and a rotating anode, and emits X-rays from a surface of the rotating anode by causing an electron beam emitted from the electron gun to impinge on the rotating anode; and
an X-ray optical system including a focusing optical system for focusing X-rays emitted from the X-ray source, wherein the X-ray source is arranged at a position where the X-ray source does not interfere with the sample stage, and is configured to focus the X-rays on a full width at half maximum (FWHM) of 50 μm or less (preferably 20 μm or less) on the surface of the semiconductor wafer.

Here, it is preferable that the rotating anode of the X-ray source is formed of aluminum or chromium.

Furthermore, the X-ray optical system may further comprise:
a collimating optical system for converting the X-rays emitted from the X-ray source into a parallel beam; and
a planar crystal optical system that has a surface formed of a flat surface and causes the X-rays collimated by the collimating optical system to enter the flat surface to extract X-rays of a specific bandwidth, and the X-ray optical system may be configured such that the X-rays of the bandwidth extracted from the planar crystal optical system are focused by the focusing optical system, and irradiated onto the surface of the semiconductor wafer.

The X-ray optical system may be configured to collimate the X-rays emitted from the X-ray source, extract X-rays of a specific bandwidth from the X-rays, and focus the extracted X-rays of the specific bandwidth to irradiate the semiconductor wafer with the X-rays.

The planar crystal optical system may be configured by a single crystal planar monochromator that is made of a single crystal and has a surface formed of a flat surface.

The planar crystal optical system may be configured by a channel-cut monochromator obtained by combining two single crystal planar monochromators each of which is made of a single crystal and has a surface formed of a flat surface.

The X-ray source may further comprise a focusing unit that focuses the X-rays emitted from the surface of the rotating anode, and an aperture that is disposed at a focal point of the X-rays to be focused by the focusing unit and transmits the X-rays focused at the focal point, and the aperture may be configured to limit a transmission width of the X-rays focused by the focusing unit, and have a function of emitting X-rays toward the X-ray optical system using the aperture as a virtual light source.

Here, it is preferable that the aperture is configured to limit a transmission width of X-rays to a full width at half maximum of 50 μm or less (further preferably 20 μm or less).

The X-ray source may be configured such that the rotating anode has a plurality of target regions made of different materials respectively, and an electron beam emitted from the electron gun is caused to impinge on any one of the target regions.

Here, it is preferable that the rotating anode of the X-ray source includes at least an Al target region made of aluminum and a Cr target region made of chromium.

An X-ray photoelectron spectroscopy according to the present invention includes a sample stage having a movable range where it is possible to inspect an entire surface of a semiconductor wafer having a diameter of 300 mm or more, and is incorporated with the X-ray optical device having the above-mentioned configuration.

### BRIEF DESCRIPTION OF THE DRAWINGS

FIG. 1 is a schematic diagram showing a general configuration of an X-ray photoelectron spectroscopy according to an embodiment of the present invention;

FIG. 2 is a schematic diagram showing a first configuration example of an X-ray optical device according to an embodiment of the present invention;

FIG. 3 is a schematic diagram showing a configuration of an X-ray source in the X-ray optical device shown in FIG. 2;

FIG. 4 is a schematic diagram showing a modification of the X-ray optical device shown in FIG. 2;

FIG. 5A and FIG. 5B are schematic diagrams showing a configuration of a channel-cut monochromator shown in FIG. 4;

FIG. 6 is a schematic diagram showing a second configuration example of an X-ray optical device according to the embodiment of the present invention;

FIG. 7 is a schematic diagram showing a modification of the X-ray optical device shown in FIG. 6;

FIG. 8 is a schematic diagram showing another modification of the X-ray optical device shown in FIG. 6;

FIG. 9 is a schematic diagram showing a modification of the X-ray source; and

FIG. 10 is a schematic diagram showing an X-ray optical device incorporated in a conventional X-ray photoelectron spectroscopy.

### DETAILED DESCRIPTION OF THE PREFERRED EMBODIMENTS

Embodiments of the present invention will be described in detail with reference to the drawings.

### Outline of X-Ray Photoelectron Spectroscopy

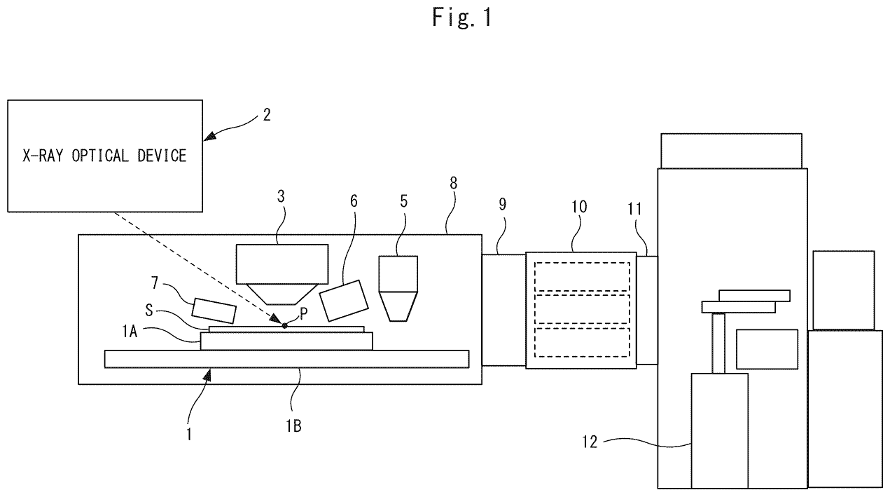

First, an outline of an X-ray photoelectron spectroscopy according to an embodiment will be described with reference to FIG. 1.

The X-ray photoelectron spectroscopy includes a sample stage 1, an X-ray optical device 2, and a photoelectron energy analyzer 3 as basic components thereof.

The sample stage 1 includes a sample table 1A on which a semiconductor wafer as a sample is mounted, and a drive mechanism 1B for moving the sample table 1A in a horizontal direction (X-Y direction) and a height direction (Z direction).

This sample stage 1 has a movable range that allows the entire surface of a semiconductor wafer S having a diameter of 300 mm or more to be moved to an inspection position P set in the apparatus. For this reason, a movement space of at least 300 mm or more must be secured on a side of the sample stage 1. Furthermore, it is preferable to provide a space of 50 mm or more for mounting a sample.

The X-ray optical device 2 is a component for irradiating the inspection position P with X-rays of microfocus while focusing the X-rays on the inspection position P, and its detailed configuration will be described later. This X-ray optical device 2 is designed so as not to interfere with the sample stage 1.

The photoelectron energy analyzer 3 is a component for capturing photoelectrons emitted from a substance constituting a thin film that is formed on the surface of the semiconductor wafer when S the surface of the semiconductor wafer S is irradiated with X-rays, the photoelectrons being emitted from the substance due to ionization of the substance, and performing energy analysis.

In addition to these basic components, the X-ray photoelectron spectroscopy of the present embodiment is equipped with an optical microscope 5 and a fluorescent X-ray detector 6. The optical microscope 5 is provided for the purpose of observing a circuit pattern formed on the surface of the semiconductor wafer S and identifying a surface site of the semiconductor wafer S as an analysis target. The surface site identified by the optical microscope 5 can be located at the inspection position P by moving the sample stage 1, and the surface site can be analyzed by irradiating the surface site with X-rays.

Specifically, the pattern shape of an inspection target site set on the surface of the semiconductor wafer S is registered in advance in a controller described later, and the registered pattern shape is searched for by the optical microscope 5, thereby making it possible to move the inspection target site of that pattern shape to the inspection position P and locate the inspection target site at the inspection position P.

The fluorescent X-ray detector 6 is a component for detecting fluorescent X-rays emitted from the surface of the semiconductor wafer S when X-rays are irradiated onto the surface of the semiconductor wafer S and performing fluorescent X-ray analysis. As the fluorescent X-ray detector 6, for example, an energy dispersive X-ray detector such as an SDD with high energy resolution, or a wavelength dispersive X-ray detector with similarly high energy resolution can be applied.

In the present embodiment, the apparatus is configured to perform composite analysis based on X-ray photoelectron spectroscopy analysis using the photoelectron energy analyzer 3 and fluorescent X-ray analysis using the fluorescent X-ray detector 6. The X-ray photoelectron spectroscopy analysis and the fluorescent X-ray analysis can be performed separately from each other or performed simultaneously with each other. By simultaneously analyzing a plurality of analysis results, the analytical accuracy of the thin film of the semiconductor wafer S can be improved.

Furthermore, the X-ray photoelectron spectroscopy of the present embodiment includes various components of a charge neutralization mechanism 7, a vacuum chamber 8, a first gate valve 9 with a transfer mechanism, a vacuum reserve chamber 10, a second gate valve 11, and a transfer robot 12.

The charge neutralization mechanism 7 has a function of preventing or reducing charging of the semiconductor wafer S.

The vacuum chamber 8 is used to create a vacuum atmosphere around the semiconductor wafer S. The sample stage 1 is arranged inside this vacuum chamber 8, and the semiconductor wafer S is placed on the upper surface of the sample stage 1. In X-ray photoelectron spectroscopy analysis, the semiconductor wafer S (sample) is required to be ionized when it is irradiated with X-rays, so that at least an area around the inspection position P must be kept in a vacuum atmosphere.

Although not shown, the vacuum chamber 8 is provided with an X-ray window made of a material (for example, beryllium) that transmits X-rays therethrough. X-rays emitted from the X-ray optical device 2 provided outside are irradiated to the inspection position P through the X-ray window. If necessary, the X-ray photoelectron spectroscopy may be configured such that photoelectrons and fluorescent X-rays emitted from the surface of the semiconductor wafer S are caused to enter the photoelectron energy analyzer 3 and fluorescent X-ray detector 6 provided outside through the X-ray window. In the configuration shown in FIG. 1, the photoelectron energy analyzer 3 and fluorescent X-ray detector 6 are arranged inside the vacuum chamber 8.

The vacuum reserve chamber 10 communicates with the interior of the vacuum chamber 8 via a first gate valve 9. A slot capable of accommodating a plurality of semiconductor wafers S is provided inside the vacuum reserve chamber 10.

Although not shown in FIG. 1, a vacuum pump is connected to the vacuum chamber 8 and the vacuum reserve chamber 10 to evacuate the interiors thereof.

The transfer robot 12 has a function of receiving the semiconductor wafers S sent from a semiconductor manufacturing apparatus and transferring them to the vacuum reserve chamber 10. The vacuum reserve chamber 10 communicates with a mount space for the transfer robot 12 via a second gate valve 11.

When the transfer robot 12 receives a semiconductor wafer S sent from the semiconductor manufacturing apparatus, the second gate valve 11 is opened. Then, after the transfer robot 12 places the semiconductor wafer S in the vacuum reserve chamber 10, the second gate valve 11 is closed again and the inside of the vacuum reserve chamber 10 is evacuated.

When the semiconductor wafer S is placed on the sample stage 1, the first gate valve 9 is opened, and the semiconductor wafer S in the vacuum reserve chamber 10 is placed on the sample stage 1 by a transfer mechanism incorporated in the first gate valve 9. Thereafter, the first gate valve 9 is closed.

Meanwhile, the semiconductor wafer S for which the measurement has been completed is returned to the vacuum reserve chamber 10 and then returned to the semiconductor manufacturing apparatus by the transfer robot 12.

By accommodating a plurality of semiconductor wafers S in the vacuum reserve chamber 10 as described above, it is possible to efficiently perform an analysis work for the semiconductor wafers S.

Although not shown in FIG. 1, the X-ray photoelectron spectroscopy includes a controller for controlling the operation of each component, and an analyzer for performing X-ray photoelectron spectroscopy analysis based on the photoelectrons detected by the photoelectron energy analyzer 3. Specifically, the controller and the analyzer are configured by a computer and software. The analyzer also has a function of performing fluorescent X-ray analysis based on the fluorescent X-rays detected by the fluorescent X-ray detector 6.

### X-Ray Optical Device 2—First Configuration Example

Next, the X-ray optical device will be described in detail with reference to the drawings.

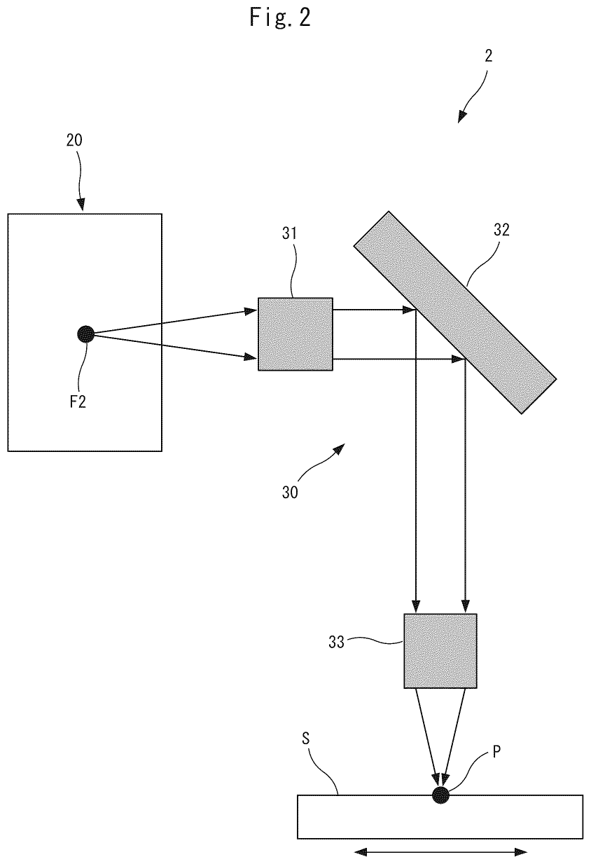

FIG. 2 is a schematic diagram showing a first configuration example of the X-ray optical device according to an embodiment.

The X-ray optical device 2 includes an X-ray source 20 and an X-ray optical system 30.

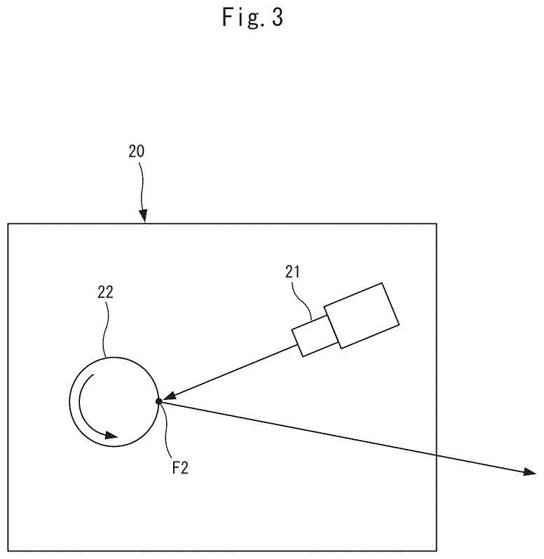

The X-ray source 20 is a rotating anode type X-ray source 20. Specifically, as shown in FIG. 3, the X-ray source 20 includes an electron gun 21 and a rotating anode 22, and has a function of emitting X-rays from the surface of the rotating anode 22 by causing an electron beam emitted from the electron gun 21 to impinge on the rotating anode 22.

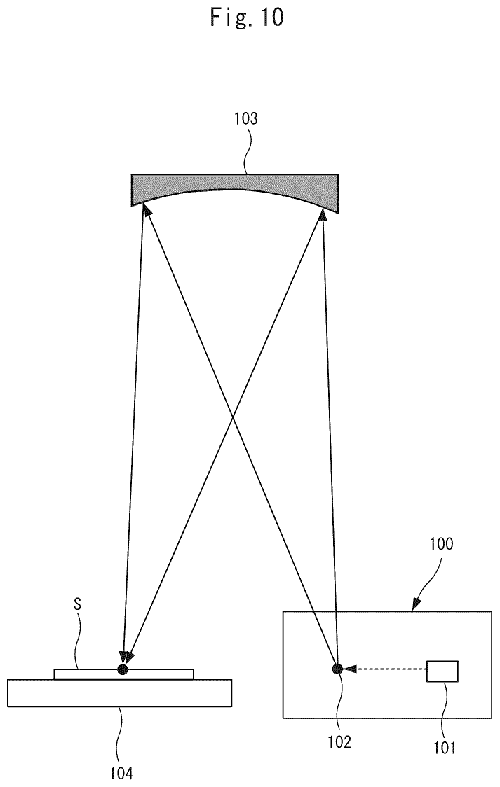

As far as the applicant knows, there is no conventional X-ray photoelectron spectroscopy that uses a rotating anode type X-ray source 20. As shown in FIG. 10, in a normal X-ray photoelectron spectroscopy, a high-angle reflecting monochromator 103 must be adopted in order to obtain high energy resolution. In such an optical system, an X-ray source 100 and a sample stage 104 are close to each other. When the X-ray source 100 is a rotating anode type, it is large in size as compared with other radiation sources, and therefore, when the X-ray source is simply arranged, interference occurs between the sample stage 104 and the rotating anode type X-ray source.

The type of X-rays emitted from the X-ray source 20 corresponds to the material forming the rotating anode 22. For example, Al-Ka (1.487 KeV) or CrKa (5.412 KeV) is suitable as X-rays to be used in X-ray photoelectron spectroscopy of semiconductor wafers S. Therefore, in the present embodiment, it is preferable to form the rotating anode 22 from Al or Cr.

By using high-energy X-rays such as CrKa (5.412 KeV), it is possible to emit photoelectrons at deep positions below the surface of the semiconductor S, wafer but the photoelectron emission efficiency decreases. As described above, the characteristics differ depending on the type of X-rays, it goes without saying that the material forming the rotating anode 22 can be appropriately selected as necessary.

The rotating type anode X-ray source 20 is characterized by its ability capable of emitting X-rays of high intensity (high brightness).

On the other hand, the apparatus tends to become larger because it is incorporated with the rotating anode 22. Therefore, it is required to make such an improvement that the device is installed at a position away from the sample stage 1 so as not to restrict the movable range of the sample stage 1.

Therefore, the apparatus is configured such that even when the X-ray source 20 is installed at a position where it does not interfere with the sample stage 1, the X-ray optical system 30 leads X-rays to the surface of the semiconductor wafer S.

The X-ray optical system 30 is configured by a plurality of optical systems having different functions. Specifically, the X-ray optical system 30 includes a collimating optical system 31, a planar crystal optical system 32, and a focusing optical system 33.

The collimating optical system 31 has a function of converting the X-rays emitted from the X-ray source 20 into a parallel beam.

The planar crystal optical system 32 has a function of receiving the X-rays collimated by the collimating optical system 31 and diffracting and extracting X-rays of a specific bandwidth. This planar crystal optical system 32 is configured by a single crystal planar monochromator having an X-rays incident surface which is formed in a planar shape. By forming the X-rays incident surface in a planar shape, there is less surface error as compared with a case where the surface is formed in a curved shape, and it is possible to extract desired X-rays with high precision.

The bandwidth of the X-rays extracted by the planar crystal optical system 32 is determined by the convolution of the spectrum of the X-rays emitted from the X-ray source 20 and the rocking curve of the single crystal planar monochromator. By using different types of single crystal planar monochromators, X-rays of different bandwidths can be extracted.

The focusing optical system 33 has a function of irradiating an inspection position P set in the X-ray photoelectron spectroscopy with X-rays of the bandwidth extracted by the planar crystal optical system 32 while focusing the X-rays on the inspection position P.

A site selected as the inspection target on the surface of the semiconductor wafer S placed on the sample stage 1 is positioned at the inspection position P by movement of the sample stage 1.

The focal size of the X-rays with which the inspection position P is irradiated is roughly determined by the focal size of the X-rays in the X-ray source 20, the roughness accuracy of the surface that reflects the X-rays in the collimating optical system 31, and the roughness accuracy and shape of the focusing optical system 33. Furthermore, the focal size of the X-rays with which the inspection position P is irradiated can be made even smaller by suppressing the divergence of the X-rays diffracted from the planar crystal optical system 32 (single crystal planar monochromator).

Next, specific configuration examples of the collimating optical system 31, the planar crystal optical system 32, and the focusing optical system 33 that make up the above-mentioned X-ray optical system 30 will be described.

The collimating optical system 31 can be configured by any one of a parabolic mirror, a Kirkpatrick-Baez optical system, and a collimating polycapillary optical system. The Kirkpatrick-Baez optical system has two parabolic mirrors arranged back and forth or left and right.

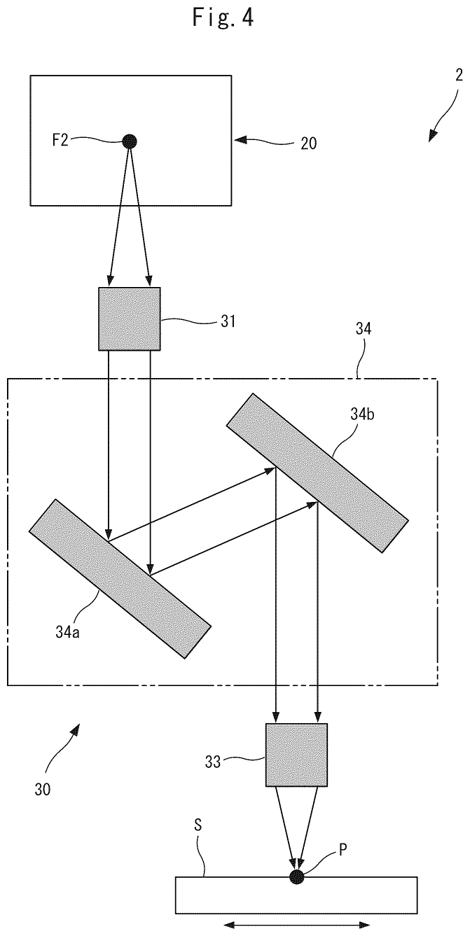

As shown in FIG. 4, the planar crystal optical system 32 can also be configured by a channel-cut monochromator 34. The channel-cut monochromator 34 is configured by two independent single crystal planar monochromators 34a, 34b whose relative angles with respect to the diffraction plane can be adjusted. The channel-cut monochromator 34 has the feature that the bandwidth of X-rays to be extracted can be changed by adjusting the relative angles with respect to the diffraction plane the single crystal planar of monochromators 34a, 34b.

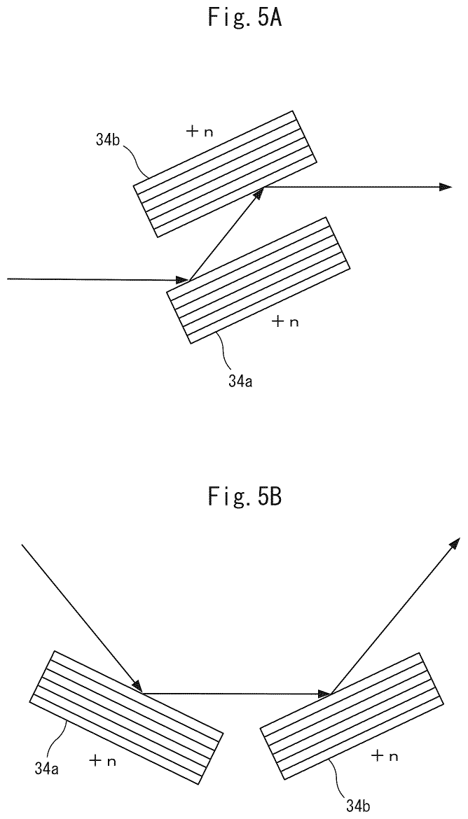

The two single crystal planar monochromators 34a, 34b constituting the channel-cut monochromator 34 can be arranged in either a non-dispersive geometry (+, −) shown in FIG. 5A or a dispersive geometry (+, +) shown in FIG. 5B.

Like the collimating optical system 31, the focusing optical system 33 can be configured by any one of a parabolic mirror, a Kirkpatrick-Baez optical system, and a polycapillary optical system.

Here, the parabolic mirrors constituting the planar crystal optical system 32 and the focusing optical system 33 can be configured by total reflection mirrors or multilayer coated mirrors. The two parabolic mirrors that constitute the Kirkpatrick-Baez optical system can also be configured by total reflection mirrors or multilayer coated mirrors.

### X-Ray Optical Device 2—Second Configuration Example

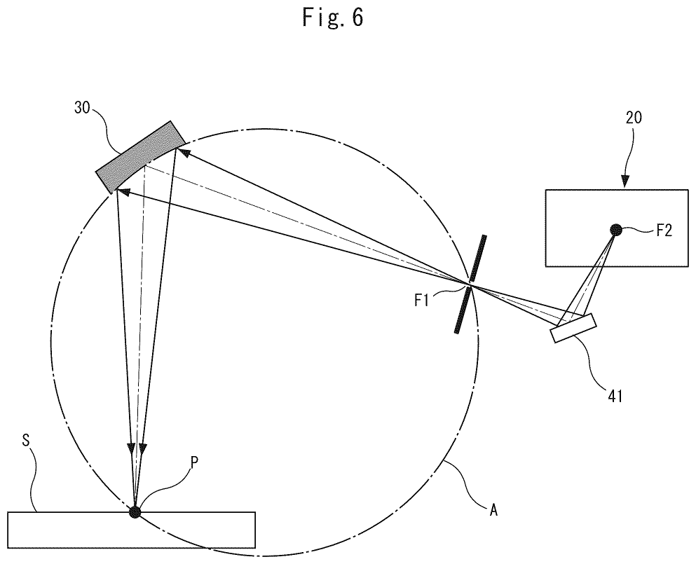

FIG. 6 is a schematic diagram showing a second configuration example of the X-ray optical device according to the present embodiment.

The X-ray optical device 2 shown in FIG. 6 includes an X-ray source configured by adding a focusing unit 41 and an aperture 42 to the X-ray source 20 configured by the electron gun 21 and rotating anode 22 described above.

The focusing unit 41 has a function of focusing X-rays emitted from the surface of the rotating anode 22 incorporated in the X-ray source 20. This focusing unit 41 can be configured, for example, by a parabolic mirror made up of a total reflection mirror or a multilayer coated mirror like the focusing optical system 33 described above.

The aperture 42 is arranged at a focal position F1 where X-rays collected by the focusing unit 41 are focused, and has a function of limiting the transmission width of the X-rays focused by the focusing unit 41. For example, the aperture 42 can be configured, for example, such that a pinhole is provided in a shielding plate for blocking X-rays and the transmission width of the X-rays passing through the pinhole is limited by adjusting the dimension and shape of the pinhole. The shape of the pinhole may be formed into an appropriate shape such as a circle or a rectangle as necessary. The size of the aperture 42 may be made changeable depending on the size of the target irradiation area.

The X-ray optical device 2 shown in FIG. 6 is configured such that the aperture 42 is used as a virtual light source and X-rays transmitted through the aperture 42 are emitted toward the X-ray optical system 30. As described above, the focal size of the X-rays with which the inspection position P is irradiated changes depending on the focal size of the X-rays in the X-ray source 20. Specifically, if the focal size of the X-rays in the X-ray source 20 is reduced, the focal size of the X-rays with which the inspection position P is irradiated correspondingly becomes smaller. Therefore, by limiting the transmission width of the X-rays using the aperture 42, it is possible to create a focal spot that is smaller than the focal size of the X-rays located on the surface of the rotating anode 22.

For example, when the focal size of the X-rays to be focused on the inspection position P set on the surface of the semiconductor wafer S is set to have a full width at half maximum (FWHM) of 50 μm or less, it is preferable that the transmission width of the X-rays by the aperture 42 is similarly limited to a full width at half maximum (FWHM) of 50 μm or less.

Furthermore, when the focal size of the X-rays to be focused on the inspection position P set on the surface of the semiconductor wafer S is set to have a full width at half maximum (FWHM) of 20 μm or less, it is preferable that the transmission width of the X-rays by the aperture 42 is similarly limited to a full width at half maximum (FWHM) of 20 μm or less.

The focal position F1 of the X-rays transmitting through the aperture 42 is adjusted in accordance with a condition required for the X-ray optical system 30 to focus the X-rays on the inspection position P. For example, in an arrangement based on a focusing method of X-ray diffraction, the focal position F1 of the X-rays transmitting through the aperture 42 may be arranged on a Rowland circle A.

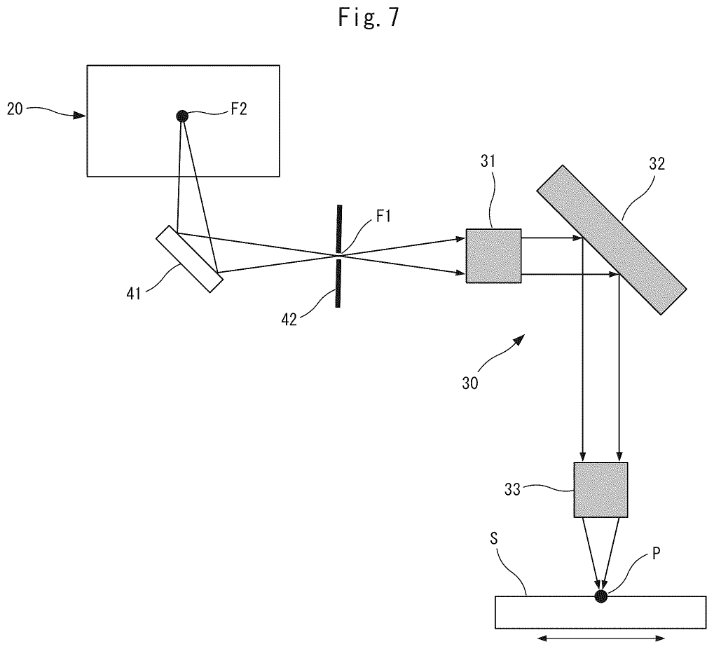

FIG. 7 shows a configuration example in which the focusing unit 41 and the aperture 42 are added to the X-ray source 20 of the X-ray optical device 2 shown in FIG. 2. In other words, the focal position F1 of the X-rays transmitting through the aperture 42 is arranged at the focal position F2 of the X-ray source 20 shown in FIG. 2.

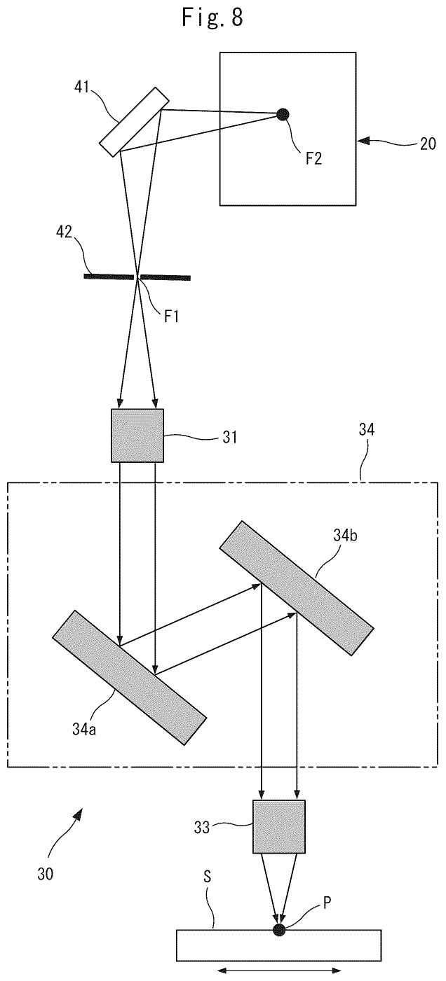

FIG. 8 shows a configuration example in which a focusing unit 41 and an aperture 42 are added to the X-ray source 20 of the X-ray optical device 2 shown in FIG. 4. In other words, the focal position F1 of the X-rays transmitting through the aperture 42 is arranged at the focal position F2 of the X-ray source 20 shown in FIG. 4.

As shown in FIG. 7 and FIG. 8, it is possible to combine the optical system using the aperture 42 as a virtual light source with the optical system using the planar crystal optical system 32 or the channel-cut monochromator 34. By using such a combination, it is possible to obtain both an effect of reducing the focal size of the light source and an effect of reducing or enlarging the focal point. Therefore, it is possible to efficiently reduce the irradiation width of the X-rays at the sample position.

### Modifications and Applications

The present invention is not limited to the above-described embodiments, and various modifications or applications are possible as necessary.

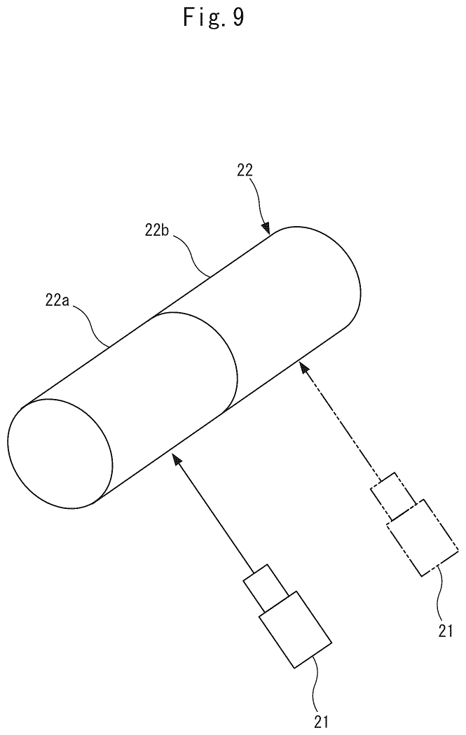

For example, as shown in FIG. 9, the X-ray source 20 may be configured such that the rotating anode 22 includes a plurality of target regions 22a, 22b which are made of different materials. For example, when the rotating anode 22 is configured to include an Al target region made of aluminum and a Cr target region made of chromium, it is possible to selectively emit Al-Ka (1.487 KeV) and CrKa (5.412 KeV) X-rays which are suitable for X-ray photoelectron spectroscopy analysis of semiconductor wafers S.

An electron beam emitted from the electron gun 21 is caused to selectively impinge on either the target region 22a or 22b.

When the X-ray source 20 is configured such that the rotating anode 22 is moved with respect to the fixed electron gun 21 to cause the electron beam to impinge on either the target region 22a or 22b, the path of the emitted X-rays does not change. Therefore, it is necessary that in accordance with the type of X-rays to be emitted, the X-ray optical system 30 for the X-rays is required to be moved and arranged onto the path of the X-rays. For this reason, it is preferable to also provide a mechanism for moving the X-ray optical system 30.

On the other hand, when the X-ray source 20 is configured such that the electron gun 21 is moved with respect to the fixed rotating anode 22 to cause the electron beam to impinge on either the target region 22a or 22b, the path of the emitted X-rays will change. Therefore, it is preferable that in accordance with the type of X-rays to be emitted, the X-ray optical system 30 for the X-rays is required to be installed on each X-ray path.

The X-ray photoelectron spectroscopy of the present invention can also be provided with a wavelength-dispersive X-ray detector with high energy resolution to configure an X-ray composite analysis system that can also perform energy-dispersive X-ray spectroscopy (XES: X-ray Energy Spectroscopy) in combination.

Furthermore, the X-ray photoelectron spectroscopy of the present invention can also be provided with a two-dimensional X-ray detector to configure an X-ray composite analysis system that can also perform X-ray diffraction measurement (XRD: X-ray Diffraction) and small angle scattering measurement (SAXS: Small Angle X-ray Scattering) in combination.

Still furthermore, the X-ray photoelectron spectroscopy of the present invention can also compensate for high-precision measurement results by placing a standard sample on a part of the sample stage 1 and measuring the standard sample periodically or at any time to correct measurement errors caused by changes in components over time, etc.

What is claimed is:

1. An X-ray optical device that is incorporated in an X-ray photoelectron spectroscopy including a sample stage having a movable range where it is possible to inspect an entire surface of a semiconductor wafer having a diameter of 300 mm or more, and irradiates the surface of the semiconductor wafer with X-rays, comprising:
a rotating anode type X-ray source that includes an electron gun and a rotating anode, and emits X-rays from a surface of the rotating anode by causing an electron beam emitted from the electron gun to impinge on the rotating anode; and
an X-ray optical system including a focusing optical system for focusing X-rays emitted from the X-ray source, wherein the X-ray source is arranged at a position where the X-ray source does not interfere with the sample stage, and is configured to focus the X-rays on a full width at half maximum (FWHM) of 50 μm or less on the surface of the semiconductor wafer.

2. The X-ray optical device according to claim 1, wherein the rotating anode of the X-ray source is formed of aluminum or chromium.

3. The X-ray optical device according to claim 1, wherein the X-ray optical system further comprises:
a collimating optical system for converting the X-rays emitted from the X-ray source into a parallel beam; and
a planar crystal optical system that has a surface formed of a flat surface and causes the X-rays collimated by the collimating optical system to enter the flat surface to extract X-rays of a specific bandwidth, and the X-ray optical system is configured such that the X-rays of the bandwidth extracted from the planar crystal optical system are focused by the focusing optical system, and irradiated onto the surface of the semiconductor wafer.

4. The X-ray optical device according to claim 3, wherein the X-ray optical system is configured to collimate the X-rays emitted from the X-ray source, extract X-rays of a specific bandwidth from the X-rays, and focus the extracted X-rays of the specific bandwidth to irradiate the semiconductor wafer with the X-rays.

5. The X-ray optical device according to claim 3, wherein the planar crystal optical system is configured by a single crystal planar monochromator that is made of a single crystal and has a surface formed of a flat surface.

6. The X-ray optical device according to claim 5, wherein the planar crystal optical system is configured by a channel-cut monochromator obtained by combining two single crystal planar monochromators each of which is made of a single crystal and has a surface formed of a flat surface.

7. The X-ray optical device according to claim 1, wherein the X-ray source further comprises a focusing unit that focuses the X-rays emitted from the surface of the rotating anode, and an aperture that is disposed at a focal point of the X-rays to be focused by the focusing unit and transmits the X-rays focused at the focal point, the aperture being configured to limit a transmission width of the X-rays focused by the focusing unit, and having a function of emitting X-rays toward the X-ray optical system using the aperture as a virtual light source.

8. The X-ray optical device according to claim 7, wherein the aperture is configured to limit a transmission width of X-rays to a full width at half maximum of 50 μm or less.

9. The X-ray optical device according to claim 5, wherein the X-ray source further comprises a focusing unit that focuses the X-rays emitted from the surface of the rotating anode, and an aperture that is disposed at a focal point of the X-rays to be focused by the focusing unit and transmits the X-rays focused at the focal point, the aperture being configured to limit a transmission width of the X-rays focused by the focusing unit, and having a function of emitting X-rays toward the X-ray optical system using the aperture as a virtual light source.

10. The X-ray optical device according to claim 9, wherein the aperture is configured to limit a transmission width of X-rays to a full width at half maximum of 50 μm or less.

11. The X-ray optical device according to claim 6, wherein the X-ray source further comprises a focusing unit that focuses the X-rays emitted from the surface of the rotating anode, and an aperture that is disposed at a focal point of the X-rays to be focused by the focusing unit and transmits the X-rays focused at the focal point, the aperture being configured to limit a transmission width of the X-rays focused by the focusing unit, and having a function of emitting X-rays toward the X-ray optical system using the aperture as a virtual light source.

12. The X-ray optical device according to claim 11, wherein the aperture is configured to limit a transmission width of X-rays to a full width at half maximum of 50 μm or less.

13. The X-ray optical device according to claim 1, wherein the X-ray source is configured such that the rotating anode has a plurality of target regions made of different materials, and an electron beam emitted from the electron gun is caused to impinge on any one of the target regions.

14. The X-ray optical device according to claim 13, wherein the rotating anode of the X-ray source includes at least an Al target region made of aluminum and a Cr target region made of chromium.

15. An X-ray photoelectron spectroscopy including a sample stage having a movable range where it is possible to inspect an entire surface of a semiconductor wafer having a diameter of 300 mm or more, the X-ray photoelectron spectroscopy being incorporated with the X-ray optical device of claim 4.

16. An X-ray photoelectron spectroscopy including a sample stage having a movable range where it is possible to inspect an entire surface of a semiconductor wafer having a diameter of 300 mm or more, the X-ray photoelectron spectroscopy being incorporated with the X-ray optical device of claim 5, and the X-ray source being arranged at a position where the X-ray source does not interfere with the sample stage.

17. An X-ray photoelectron spectroscopy including a sample stage having a movable range where it is possible to inspect an entire surface of a semiconductor wafer having a diameter of 300 mm or more, the X-ray photoelectron spectroscopy being incorporated with the X-ray optical device of claim 6, and the X-ray source being arranged at a position where the X-ray source does not interfere with the sample stage.

18. An X-ray photoelectron spectroscopy including a sample stage having a movable range where it is possible to inspect an entire surface of a semiconductor wafer having a diameter of 300 mm or more, the X-ray photoelectron spectroscopy being incorporated with the X-ray optical device of claim 8, and the X-ray source being arranged at a position where the X-ray source does not interfere with the sample stage.

19. An X-ray photoelectron spectroscopy including a sample stage having a movable range where it is possible to inspect an entire surface of a semiconductor wafer having a diameter of 300 mm or more, the X-ray photoelectron spectroscopy being incorporated with the X-ray optical device of claim 10, and the X-ray source being arranged at a position where the X-ray source does not interfere with the sample stage.

20. An X-ray photoelectron spectroscopy including a sample stage having a movable range where it is possible to inspect an entire surface of a semiconductor wafer having a diameter of 300 mm or more, the X-ray photoelectron spectroscopy being incorporated with the X-ray optical device of claim 12, and the X-ray source being arranged at a position where the X-ray source does not interfere with the sample stage.
